(19) United States
(12) Patent Application Publication
(10) Pub. No.: US 2009/0163630 A1
(43) Pub. Date: Jun. 25, 2009

(54) SOLID FILLER COMPOSITIONS

(75) Inventors: Gary Jefferson, Berkshire (GB); Laura Knight, London (GB)

Correspondence Address: ROETZEL AND ANDRESS, 222 SOUTH MAIN STREET, AKRON, OH, 44308, US

(73) Assignee: IMPERIAL CHEMICAL INDUSTRIES PLC, London, GB (GB)

(21) Appl. No.: 12/066,563

(22) PCT Filed: Mar. 15, 2007
(86) PCT No.: PCT/EP07/02291

§ 371 Date: Oct. 30, 2008

(30) Foreign Application Priority Data
Mar. 31, 2006 (GB) GB0606468.7
Dec. 20, 2006 (GB) GB0625402.3

(51) Int. Cl. C09D 5/34; C08K 3/34; C08K 3/16; C08K 3/32; C08K 5/29

(52) U.S. Cl. 524/186; 524/445; 524/438; 524/415

(57) ABSTRACT

A solid filler composition suitable for applying directly to a substrate comprising
i) binder polymer
ii) fatty acid salt of linear chain length of from 12 to 26 carbon atoms
iii) pigment
   said composition capable of being formed into a self-supporting, dimensionally stable filler body.

The present invention relates to fillers, caulks and grouts, especially those used to repair surface defects, especially small cracks in walls and ceilings.

Interior walls are usually constructed using building blocks such as bricks or breeze blocks. The interior surfaces of the walls are normally provided with a smooth finish ready for decorating. The finish is typically a plaster layer of 2-5 mm thickness, either mixed on site and applied as a viscous paste to the wall and allowed to dry in situ; or is provided in the form of a coated board coated with dried plaster, known as plasterboard. The plasterboard can be fixed to the wall directly and decorated.

Walls and ceilings finished with a layer of plaster may form cracks soon after application as the plaster dries or perhaps over a longer period due to gradual settlement of the building structure itself. Alternatively, the plaster layer may also be damaged by careless use of household equipment such as a vacuum cleaner or other domestic items, such as furniture and toys.

Fillers, caulks and grouts are types of plaster normally used to fill cracks and other defects in the plaster layer applied to interior walls. For simplicity, in this specification, the term fillers is used to include caulks and grouts.

Fillers can be of the powder variety, consisting of inorganic material such as calcium sulphate hemihydrate (CaSO₄.1/2H₂O), which a user mixes with water to a desired viscosity. The filler composition hardens as the hemihydrate converts to the dihydrate whilst any excess water is lost by evaporation.

Alternatively, the filler may be ready-mixed, in which case it comprises a mixture of an aqueous polymer dispersion and an inorganic particulate material. In such cases, and where calcium sulphate is used as the inorganic material, it is as the dihydrate, the fully hardened form.

Known ways to repair such defects are to make a sufficient quantity of a powder filler or to use a ready mixed filler and repair the defect by filling with a quantity of filler. Normally, a blade is used to achieve a reasonably smooth finish which, when a finer finish is required, can be optionally sanded. Usually sanding is required to achieve the optimum finish.

In the former case, a messy process is involved as it requires mixing a dusty powder with water to achieve an optimum consistency of filler to allow filling of the defect. Whilst the skilled tradesman is adept at this the amateur is not. In addition, there is almost always a quantity of filler which is surplus to requirement and must be discarded. Finally, the tools used to mix and apply the filler must be cleaned after use. This is a particularly tiresome and messy job. Using ready mixed filler overcomes some of these problems but the tools and container still require cleaning.

The use of wax sticks is known as a means of repairing defects in wood, for example of tables or unpainted doors and wooden furniture. However, such sticks are of no use on a plaster wall or ceiling, which, if left unpainted following repair with such a stick will appear glossy against a background of the matt finish of the plaster. Similarly, painting over a wax substrate is likely to produce defects in the paint such as craters and pinholes, due to the poor wetting of the coating over the hydrophobic surface produced by the wax.

So called patch sticks are also used to fill nail holes and small cracks. Although these are described as sticks, they are in fact pastes—that is, conventional, but high viscosity liquid fillers. They thus suffer the problems described above.

It is an object of this invention to overcome the problems described by providing a filler composition in substantially solid form and which can be applied directly to the wall or ceiling.

In a first aspect of the invention there is provided a solid filler composition suitable for applying directly to a substrate comprising
i) binder polymer
ii) fatty acid salt of linear chain length from 12 to 26 carbon atoms
iii) pigment
said composition capable of being formed into a self-supporting, dimensionally stable filler body.

In a second aspect of the invention there is provided a solid filler composition when formed into a self-supporting, dimensionally stable filler body.

In a third aspect of the invention there is provided a filler body in an applicator.

The filler composition in this form is particularly suited to filling cracks of up to about 2 to 3 mm wide and about 2 to 3 mm deep.

By self-supporting is meant that the filler body is sufficiently strong that the action of urging the body against a substrate, in order to fill a crack, does not cause it to fracture, break or lose its overall form.

Preferably the filler body is moulded as a cylinder in a tubular applicator, the applicator having a propelling mechanism. The applicator may have a cap to prevent the exposed surface of the filler body from drying out. Such applicators are of the same type commonly used for deodorant sticks and glue sticks. In use, the exposed surface is applied to the region of a crack. The action of pressing the filler body to the wall and moving it to and fro will shear it sufficiently so that the filler flows to fill the crack. The propelling mechanism allows new surface to be exposed beyond the neck of the applicator.

The filler composition optionally comprises a clay thickener and/or a thermal stabilising agent.

The clay thickener increases the hardness of the filler body and also improves the application properties. In particular, when applying the filler to a defect in a substrate, the filler glides smoothly and evenly over it rather than requiring much effort to work the filler.

Thermal stabilising agents serve to increase the dimensional stability of the filler composition when formed into a solid filler body, especially at elevated temperatures. These agents are discussed in more detail below.

Preferably the filler composition is aqueous. By aqueous is meant that at least 50% of the total volatile content of the composition is water ensuring that the volatile organic content, or VOC, is minimised. Preferably the VOC is from 0 to 20%, more preferably from 0 to 10%, even more preferably from 0 to 5% and most preferably it is 0%.

Preferably, the filler composition should produce a hardness of the filler body, as measured by the method and apparatus described hereinbelow, of at least 130 g, more preferably from 200 to 950 g, even more preferably from 300 to 900 g, still more preferably from 350 to 850 g, and most preferably from 400 to 850 g. Filler compositions of hardness values greater than 1250 g are difficult to get to flow well.

The filler composition should preferably retain its dimensional stability over a wide temperature range. However, filler compositions containing fatty acid salts exhibit a melting temperature above which they become substantially liquid. Preferably, they have a melting temperature of at least 40° C., more preferably 50° C.

We have found that the hardness of the filler body increases as the fatty acid chain length increases and thus less of the fatty acid salt is required on a weight basis, in the filler formulation. Usually, at least 0.5% by weight of the salt based on overall formulation is required to achieve adequate structure. As a guide, preferably from 0.5 to 10%, more preferably from 2.0 to 10.0%, even more preferably from 2 to 8% and most preferably it is from 2 to 7%. Fatty acids of carbon chain length greater than 22 are difficult to obtain but we believe that fatty acid salts up to and including C₃₀ are useful in the invention. Fatty acid salts with carbon chain length less than about 12 produce so little structure that they are not especially useful in this invention.

The level and type of fatty acid salt is selected so that sufficient structure is generated to give the filler the solidity required to make it self-supporting whilst not causing the yield point and/or high shear viscosity to be so high that it becomes difficult to impart sufficient shear stress to make the filler flow, especially by hand. Similarly, the fatty acid salt must not be so short that the filler, when formed into a block and applied to a substrate, is too weak to be self-supporting.

The fatty acid may be branched or linear; unsaturated or saturated and of linear carbon chain length of from 12 to 26. Advantageously, the fatty acid is a saturated aliphatic acid of linear carbon chain length from 12 to 24 carbon atoms. More preferably, the carbon chain length is from 14 to 24, even more preferably it is from 14 to 22 and most preferably it is 18, stearic acid. When the fatty acid is stearic acid, the preferred amount to use in the formulation is from 2.5 to 4.5%, more preferably from 2.5 to 3.5% by weight.

Commercially available fatty acids are usually obtained from natural plant or animal material and comprise mixtures of different fatty acids. Nevertheless, they can be used so long as the average chain length and unsaturation is within the limits described above. However, whichever fatty acid is selected, it is preferable to use the purest form available as this will produce the hardest filler body.

It is thought that the fatty acid salt produces a three dimensional structure throughout the filler body which is strong enough at rest or low shear stress to be self-supporting, but which in regions of high shear stress and/or high shear rate, such as found in the zone between the filler body and the surface defect being filled, breaks down easily so that the filler becomes fluid enough to fill the defect to leave a relatively smooth finish when dry and which may be optionally sanded.

The force required to render the solid filler flowable should preferably be sufficiently low that it may be applied by hand. It is thought that the force is related to the shear stress.

Suitable examples of fatty acid include lauric acid (C₁₂), myristic acid (C₁₄), palmitic acid (C₁₆), stearic acid (C₁₈), arachidic acid (C₂₀), behenic acid (C₂₂), lignoceric acid(C₂₄), gadoleic acid (C₂₀), erucic acid (C₂₂) and mixtures thereof.

The fatty acid is converted to the salt form by contacting the fatty acid with a neutralising base. Preferably the fatty acid salt comprises an alkali metal salt. The salt may be added preformed to the filler composition or may be formed in situ by adding the fatty acid and neutralising base separately to the filler composition.

The neutralising base may be an organic base such as ammonia or amine or, more preferably, an alkali metal hydroxide such as sodium hydroxide, potassium hydroxide and lithium hydroxide. Sodium hydroxide is most preferred as this provides the best combination of structure, providing dimensional stability, and ease of application.

Preferably, the fatty acid is at least fully neutralised with the equivalent amount of the base. This is because in the un-neutralised form the fatty acid does not form the three dimensional structure described above that is thought to give rise to the dimensional stability of the composition.

Pigments suitable for use in this invention include opacifying pigments such as titanium dioxide; and non-opacifying pigments such as extenders and fillers. Extenders and fillers are generally used to strengthen or extend the volume of the filler composition. Suitable such extenders and fillers include finely divided inorganic materials such as calcium sulphate dihydrate (CaSO₄.2H₂O), calcium carbonate, silica, Dolomite, mica, talc and non-thickening clays.

Suitable examples of clay thickeners include the naturally occurring mineral types which are found in the ground such as montmorillonite (Na, Ca)_{0.3} (Al, Mg)₂ Si₄O₁₀ (OH)₂.n(H₂O) a member of the smectite group and a major component of bentonite, also known as hectorite. Examples of such thickeners include Bentone and Claytone. Attapulgite, a magnesium aluminium silicate, is another useful natural clay thickener and examples include Attagel and EZ Gel. More recently, synthetic clays such as laponite, a synthetic layered silicate namely hydrous sodium lithium magnesium silicate, have become available. Suitable examples of Laponite include Laponite RD, RDS, S482 and SL25. Most preferred is Laponite SL25 as it is an aqueous dispersion and thus convenient to use.

Preferably the clay thickener particles have an average diameter of from 20 to 30 nanometers and an average thickness of from 0.70 to 1.5 nanometers.

Preferably the filler composition optionally comprises from 0.02 to 7.5%, preferably from 0.05 to 5.0% and more preferably from 0.1 to 4% by weight of clay thickener.

The non-thickening clays differ from the clay thickeners referred to above by the viscosity they generate. Preferably, a clay thickener is capable of generating significant viscosity at low shear of 1 s⁻¹, say 0.5 Pa·s or, more preferably with a non-Newtonian rheology profile, at low solids whereas a non-thickening clay does not. By low solids is meant about 1% by weight. Preferably, the thickener clay should be dispersed in a carrier liquid having similar solvent characteristics to those of the filler composition. More preferably, the non-Newtonian profile is pseudoplastic or thixotropic. Nevertheless, even a non-thickening clay will generate some viscosity at solids above 10-20% by weight, but these are not classed as thickeners.

Suitable examples of non-thickening clays include kaolinite, Al₂Si₂O₅(OH)₄, also known as china clay and kaolin eg Supreme, Polwhite C and Opacilite.

Preferably, the volume solids content of the filler composition is from 55 to 85%. This ensures that, on drying, the composition does not shrink significantly, thereby avoiding the need for a second application of filler to fill the crack.

The hardness of the composition is affected by temperature, with increasing temperature resulting in reduced hardness. This causes the filler body to lose its dimensional stability. In effect, the composition starts to melt and soften becoming more liquid-like and non-self supporting. Clearly, this is a problem if it happens at temperatures close to the ambient temperature at which it is to be used to fill a crack. It is thought that the effect is related to the Krafft temperature. The Krafft temperature is the minimum temperature above which surfactants, such as salts of fatty acids, form micelles. Below this temperature micelles do not form and the surfactant exists in its crystalline form even in aqueous solution. In the micellar form, the surfactant exhibits low viscosity, whereas in the crystalline form the viscosity is much higher and in the present invention provides the self-supporting structure of the composition.

Using longer chain fatty acids, for example, of carbon chain length greater than 22 helps, as it raises the melting temperature. However, compositions containing such longer chain fatty acids have a higher yield stress and require higher shear to make them flow. They thus require greater effort by the user to apply to a substrate. It is also more difficult to produce smooth final finish. In addition, the availability of the longer chain fatty acids is more difficult.

The dimensional stability of the composition can be enhanced by adding thermal stabilising agent. Such agents, in combination with the salt of the fatty acid and optionally, the clay thickener, increase the hardness and melting temperature of the paint composition. In other words, for a given amount and type of fatty acid, not only is the hardness of the filler composition raised but the temperature at which the filler is no longer dimensionally stable is increased. A further advantage of adding the stabilising agent is that should the temperature of the composition rise close to or above its melting temperature, the hardness and thus the dimensional stability recover more quickly on cooling, and to a greater extent, than if a stabilising agent was not used. This is advantageous as it means that temperature controlled storage is not necessary and furthermore, the filler composition need not be changed to suit different climatic conditions.

Surprisingly, we have found that suitable such thermal stabilising agents consist of a diverse group of compounds including alkali metal salts such as the halides; and certain sequestering agents. They appear to fall within the group known as builders. Builders are used in the field of detergents, where they are added to enhance the cleaning action of the detergent.

Preferred alkali metal halides include the alkali metal chlorides such as lithium chloride, sodium chloride and potassium chloride. Most preferred of the alkali metal chlorides is sodium chloride as it is readily available and produces a good balance of hardness and ease of spreading the filler and crack filling.

By sequestering agent is meant the class of compounds having moieties that are capable of chelating with dissolved metal ions. Preferred sequestering agents include tetrasodium pyrophosphate and tetrasodium iminodisuccinate, also available as Baypure CX100 from Bayer Chemicals. Most preferred is tetrasodium pyrophosphate as it is effective at low levels and produces greater hardness than the alkali metal halides.

Preferably, the thermal stabilising agent is selected from the group consisting of alkali metal halides and sequestering agents.

It is not known how such diverse classes of compounds produce the effects described above. These are surprising and unexpected results.

The amount of the thermal stabilising agent added will vary according to the hardness and melting temperature required. Normally up to 5% by weight is required. Preferably, it is from about 0.10 to 5.0% by weight calculated on the total weight of the composition, more preferably from 0.10 to 3% and most preferably from 0.15 to 2.5% as this produces the best balance of hardness and ease of application.

Suitable binder polymers include addition polymers and condensation polymers.

The solid filler composition contains binder polymer to help bind the inorganic particles together. Suitable such binder polymers resins include addition polymers and condensation polymers. The term polymer is used herein to describe both homopolymers and copolymers.

Suitable examples of addition polymers can be derived from acrylic acid esters and methacrylic acid esters, amides, nitriles, vinyl monomers such as styrene and its derivatives and vinyl esters such as vinyl acetate, vinyl versatate and di-alkyl maleate esters. Acrylic polymers and polymers of vinyl esters and acrylic acid esters are preferred. Especially preferred are the terperpolymers of vinyl acetate/vinyl versatate/butyl acrylate, particularly Emultex VV531.

Using the nomenclature (meth)acrylate to represent both acrylate and methacrylate, suitable (meth)acrylic acid esters include the alkyl esters, preferably methyl (meth)acrylate, propyl (meth)acrylate, butyl (meth)acrylate, 2-ethyl hexyl (meth)acrylate and alkoxy poly(oxyethylene) (meth)acrylate. Small amounts of acrylic acid and/or methacrylic acid may also be used. Hydroxy functional monomers such as hydroxy ethyl (meth)acrylate and/or hydroxy isopropyl (meth)acrylate, may also be included. Preferably the addition polymer is derived from the esters of (meth)acrylic acid.

Suitable examples of condensation polymers include polyesters and polyurethanes. Urethane-acrylic hybrid polymers, where the urethane and acrylic addition polymer portion are closely associated may also be used.

The glass transition temperature, or Tg of the addition polymer may be varied by copolymerising monomers of appropriate Tg. Similarly, by varying the amount of hard and soft monomers, the Tg of the condensation polymers may also be varied. In this way, polymers which are hard, soft or intermediate Tg can be made which can produce a range of desirable physical properties, such as hardness and ease of sanding in the dried filler. Preferably, the Tg is from −10 to 35° C., more preferably from 0 to 25° C. and yet more preferably from 5 to 20° C. and most preferably from 5 to 15° C.

Preferably the binder polymer is a dispersion polymer and more preferably the liquid carrier medium is substantially water. The weight average particle diameter of such latexes is preferably from 0.01 to 5 microns, more preferably from 0.5 to 3 microns and most preferably from 0.1 to 1 microns. Smaller particles are preferred as they are generally better binders; this is especially important at the low binders typically used when formulating solid filler compositions of the invention. Preferably they are made by emulsion polymerisation process.

In a further aspect of the invention there is provided a process of making a solid filler composition of the invention comprising the steps of
i) providing a mixture comprising binder resin, fatty acid salt, pigment and optionally a) clay thickener and b) thermal stabilising agent
ii) converting the mixture into a liquid filler composition
iii) causing the temperature of the filler composition to at least exceed the melting temperature of the fatty acid salt
iv) allowing or causing the temperature of the filler composition to fall below its melting temperature so that it becomes dimensionally stable at temperatures below 50° C.

Preferably the filler composition following step iii) is poured into a mould of the desired shape for the filler body and allowed to cool.

### Testing

Samples of the filler compositions were tested according to the following methods.

### Hardness

A Leatherhead Food Research Association texture analyser (available from Brookfield Viscometers, Harlow, Essex, CM19 5TJ, Great Britain) was used to measure the hardness of the sample at 25° C.+/−2° C.

A sample of the filler at 40-50° C. is poured into a 250 ml container and allowed to cool overnight. The hardness is measured using a 2 mm diameter stainless steel probe travelling at 1 mm s⁻¹ and 10 mm total travel.

The hardness quoted is the average of five measurements.

### Melting Temperature

The melting temperature is estimated by placing a sample of about 1 g of the filler in a small glass vial and lidded with a rubber stopper. The vial is placed in a water bath and the temperature slowly increased until the sample begins to melt. As the temperature is further increased the sample melts completely. The melting temperature quoted is the start and finish of melting.

### Crack Filling

The moulded filler body was applied direct to a plaster substrate having cracks of approximately 2 mm wide and 2 mm deep. The exposed surface of the filler body was lightly pressed onto the plaster and moved to and fro until the body at the substrate liquefied and flowed. The filling performance was assessed and any shrinkage noted. After the filler dried sandability was assessed using 100 micron grade sandpaper.

### Ingredients

The following ingredients were used in the preparation of the examples.

Tamol 731A, a carboxylated pigment dispersant available from Rohm and Haas

Company, Herald Way, Coventry, UK.

Dispelair CF246, a defoamer available from Blackburn Chemicals Ltd, Whitebirk Industrial Estate, Blackburn, Lancashire, UK.

Disponil A1580, a surfactant available from Cognis (UK) Ltd, Charleston Road, Hardley, Hythe, Southampton, Hants, UK.

Microdol H200 and H600, both dolomite extenders, (calcium magnesium carbonate) available from Omya UK Ltd, Omya House, Wyvern Business Park, Chaddesdenn, Derby, Derbyshire, UK.

Polwhite C, a kaolin available from Imerys Minerals Ltd, Par Moor Road, Par, Cornwall, UK.

Tioxide RTC 90, titanium dioxide available from Huntsman Pigments, Tioxide Europe Ltd, Haverton Hill Road, Billingham, Stockton-on-Tees, TS23 1PS.

Rocima V189, a biocide available from Thor Specialties Ltd, Wincham Avenue, Wincham, Northwich, Cheshire, UK.

Emultex VV531, an aqueous dispersion of vinyl acetate/VeoVa 10/butyl acrylate terpolymer available from Synthomer Ltd, Central Road, Templefields, Harlow, Essex, UK.

Sodium stearate available from Univar Ltd, 46, Peckover Street, Bradford, West Yorkshire, UK.

Laponite SL 25, a dispersion of synthetic clay (25% by weight in aqueous medium), available from Rockwood Additives, Widnes, Cheshire, WA8 0JU, UK.

Bentone EW is available from Elementis, De Kleetlaan 12 A, PO Box 3, 1931 Diegem, Belgium.

Tetrasodium pyrophosphate available from Chemische Fabrik, Budenheim KG, Rheinstrasse, Germany.

### EXAMPLES

The invention will now be illustrated by the following examples.

### Preparation of an Intermediate Base Filler Composition

An intermediate base filler composition was prepared according to the method described below and the ingredients listed in Table 1.

The water charge (1) was added to a first 3 litre dispersion vessel. A high speed disperser (Dispermat) fitted with a 10 cm diameter blade was introduced and the water stirred at 1000 rpm. Whilst stirring, ingredients (2) to (6) were added followed by ingredients (7) to (10). The stirrer speed was increased to 2000 rpm and the mixture stirred for a further 20 minutes to form a millbase. To a second 3 litre container was added the latex (12) followed by the biocide (11). The remaining water (13) was added and the mixture stirred at 500 rpm. The speed was reduced to 200 rpm for about 5 minutes after which the millbase was added slowly whilst stirring to form the Intermediate.

TABLE 1

| Intermediate | | |
|---|---|---|
| Millbase | wt % | wt/g |
| 1 Water | 11.76 | 235.2 |
| 2 Polyethylene Glycol 400 | 1.38 | 27.6 |
| 3 Texanol | 0.86 | 17.2 |
| 4 Tamol 731A | 1.54 | 30.8 |
| 5 Dispelair CF246 | 0.23 | 4.6 |
| 6 Disponil A1580 | 0.19 | 3.8 |
| 7 Microdol H600 | 12.94 | 258.8 |
| 8 Microdol H200 | 17.69 | 353.8 |
| 9 Polwhite C | 12.08 | 241.6 |
| 10 Tioxide RTC 90 | 21.14 | 422.8 |
| 11 Rocima V189 | 0.19 | 3.8 |
| 12 Emultex VV531 | 10.00 | 200.0 |
| 13 Water | 10.00 | 200.0 |

### Example 1

Example 1 was prepared in accordance with the recipe below. The temperature of the Intermediate (13) was raised to 80° C. whilst stirring at 200 rpm. Once the required temperature was reached the sodium stearate (14) was added and the mixture held at that temperature for a further 60 minutes after which it was poured into a cylindrical mould of the type commonly used for glue sticks, and allowed to cool.

| | wt % | wt/g |
|---|---|---|
| 14 Intermediate | 99.5 | 1990.0 |
| 15 Sodium Stearate | 0.5 | 10.0 |
| | 100.0 | 2000.0 |

### Examples 2-9

Examples 2-9 followed the same procedure as Example 1 using the ingredients shown below.

### Example 2

| | wt % | wt/g |
|---|---|---|
| 13 Intermediate | 96.5 | 1930.0 |
| 14 Sodium stearate | 3.5 | 70.0 |
| | 100.0 | 2000.0 |

### Example 3

| | wt % | wt/g |
|---|---|---|
| 13 Intermediate | 95.0 | 1900.0 |
| 14 Sodium Stearate | 5.0 | 100.0 |
| | 100.0 | 2000.0 |

### Example 4

| | wt % | wt/g |
|---|---|---|
| 13 Intermediate | 96.0 | 1920.0 |
| 14 Sodium stearate | 3.0 | 60.0 |
| 15 Laponite SL25 | 1.0 | 20.0 |
| | 100.0 | 2000.0 |

### Example 5

| | wt % | wt/g |
|---|---|---|
| 13 Intermediate | 95.5 | 1910.0 |
| 14 Sodium stearate | 3.0 | 60.0 |
| 15 Laponite SL25 | 1.0 | 20.0 |
| 16 TSPP | 0.5 | 10.0 |
| | 100.0 | 2000.0 |

### Example 6

| | wt % | wt/g |
|---|---|---|
| 13 Intermediate | 96.25 | 1925.0 |
| 14 Sodium Stearate | 3.0 | 60.0 |
| 15 Bentone EW | 0.25 | 5.0 |
| 16 TSPP | 0.5 | 10.0 |
| | 100.0 | 2000.0 |

### Example 7

| | wt % | wt/g |
|---|---|---|
| 13 Intermediate | 95.5 | 1910.0 |
| 14 Sodium Stearate | 3.0 | 60.0 |
| 15 Laponite SL25 | 1.0 | 20.0 |
| 16 NaCl | 0.5 | 10.0 |
| | 100.0 | 2000.0 |

### Example 8

| | wt % | wt/g |
|---|---|---|
| 13 Intermediate | 96.5 | 1930.0 |
| 14 Sodium stearate | 3.0 | 60.0 |
| 15 TSPP | 0.5 | 10.0 |
| | 100.0 | 2000.0 |

### Example 9

| | wt % | wt/g |
|---|---|---|
| 13 Intermediate | 95.5 | 910.0 |
| 14 Sodium Decanoate | 3.0 | 60.0 |
| 15 Laponite SL25 | 1.0 | 20.0 |
| 16 TSPP | 0.5 | 10.0 |
| | 100.0 | 2000.0 |

### Example 10

In this example the sodium palmitate was made by adding the palmitic acid, followed by the sodium hydroxide to the intermediate, whilst stirring.

| | wt % | wt/g |
|---|---|---|
| 13 Intermediate | 95.0 | 1900.0 |
| 14 Palmitic acid | 4.3 | 86.0 |
| 15 Sodium hydroxide | 0.7 | 14.0 |
| | 100.0 | 2000.0 |

Following cooling, each of the examples was evaluated. The results are shown in Table 2. Examples 1 and 9 were all too soft to be self supporting and thus no further evaluation was carried out. Example 4 was too soft to apply easily hence the crack filling capability was rated as marginal.

TABLE 2

| | | | Melting | | |
|---|---|---|---|---|---|
| | | Hardness | temp | Crack | |
| Example | Composition | g | ° C. | filling | Comments |
| 1 | 0.5% Na stearate | 0 | NA | NA | Not self supporting. Too soft. |
| 2 | 3.5% Na stearate | 451 | — | Good | Self-supporting. Crumbly. |
| 3 | 5% Na stearate | >987 | 80-85 | Good | Self-supporting. Slightly |
| | | | | | crumbly. |
| 4 | 3% Na stearate/1% Laponite | 161 | 65-75 | Marginal | Self-supporting. Too soft for |
| | SL25 | | | | easy application. |
| 5 | 3% Na stearate/1% Laponite | 661 | 75-80 | Excellent | Solid. Easy to apply. Glides |
| | SL25/0.5% TSPP | | | | easily. |
| 6 | 3% Na stearate/0.25% | 760 | 65-75 | Excellent | Solid. Easy to apply. Glides |
| | Bentone EW/0.5% TSPP | | | | easily. |
| 7 | 3% Na stearate/1% Laponite | 448 | 75-80 | Excellent | Solid. Easy to apply. Glides |
| | SL25/0.5% NaCl | | | | easily. |
| 8 | 3% Na stearate/0.5% TSPP | 807 | — | Good | Solid. Applies well but doesn't |
| | | | | | glide easily. |
| 9 | 3% Na decanoate/1% | 7 | NA | NA | Not self supporting. Too soft. |
| | Laponite SL25/0.5% TSPP | | | | |
| 10 | 5% Na palmitate | 541 | — | Good | Solid. Sticky application. |

1) A solid filler composition suitable for applying directly to a substrate comprising
i) binder polymer
ii) fatty acid salt of linear chain length of from 12 to 26 carbon atoms
iii) pigment
said composition capable of being formed into a self-supporting, dimensionally stable filler body.

2) A solid filler composition according to claim 1 when formed into a self-supporting, dimensionally stable filler body.

3) A solid filler composition according to claim 1 and further including a clay thickener.

4) A solid filler composition according to claim 1 and further including thermal stabilising agent.

5) A solid filler composition according to claim 1 wherein the fatty acid of the fatty acid salt comprises a saturated aliphatic acid.

6) A solid filler composition according to claim 5 wherein the fatty acid is stearic acid.

7) A solid filler composition according to claim 1 wherein the fatty acid salt comprises at least 0.5% by weight of the total composition.

8) A solid filler composition according to claim 1 wherein the fatty acid salt comprises from 0.5% to 10% by weight of the total composition.

9) A solid filler composition according to claim 1 wherein the fatty acid salt comprises at least 2.5% to 7.0% by weight of the total composition.

10) A solid filler composition according to claim 1 wherein the fatty acid salt comprises an alkali metal salt.

11) A solid filler composition according to claim 3 wherein the clay thickener comprises a synthetic layered silicate.

12) A solid filler composition according to claim 11 wherein the layered silicate is hydrous sodium lithium magnesium silicate.

13) A solid filler composition according to claim 3 wherein the clay thickener comprises from 0.02 to 7.5% by weight of the total composition.

14) A solid filler composition according to claim 4 wherein the thermal stabilising agent is selected from the group consisting of alkali metal halides and sequestering agents.

15) A solid filler composition according to claim 14 wherein the thermal stabilising agent is selected from the group consisting of sodium chloride, tetrasodium pyrophosphate and tetrasodium iminosuccinate.

16) A solid filler composition according to claim 4 wherein the thermal stabilising agent comprises up to 5% by weight of the total composition.

17) A solid filler composition according to claim 3 wherein the clay thickener comprises particles having an average diameter of from 20 to 30 nanometers and an average thickness of from 0.70 to 1.5 nanometers.

18) A solid filler composition according to claim 1 wherein the volume of solids of the overall composition is from 55 to 85%.

20) Use of a solid filler composition according to any one of the preceding claims to fill defects in a wall or ceiling surface.

21) A process of making a solid filler composition comprising the steps of
i) providing a mixture comprising binder resin, fatty acid salt, pigment and optionally a) clay thickener and b) thermal stabilising agent
ii) converting the mixture into a liquid filler composition
iii) causing the temperature of the filler composition to at least exceed the melting temperature of the fatty acid salt
iv) allowing or causing the temperature of the filler composition to fall below its melting temperature so that it becomes dimensionally stable at temperatures below 40° C.

22) An applicator containing a self-supporting filler body formed from the composition of claim 1.
